(19) United States
(12) Patent Application Publication
(10) Pub. No.: US 2019/0004662 A1
(43) Pub. Date: Jan. 3, 2019

(54) TOUCH-SENSITIVE ELECTRONIC DEVICE CHASSES

(71) Applicant: Essential Products, Inc., Palo Alto, CA (US)

(72) Inventors: Jason Sean Gagne-Keats, Cupertino, CA (US); David John Evans, V, Palo Alto, CA (US); Clement Puertolas, San Francisco, CA (US)

(21) Appl. No.: 16/021,436

(22) Filed: Jun. 28, 2018

Related U.S. Application Data
(60) Provisional application No. 62/559,301, filed on Sep. 15, 2017.
(60) Provisional application No. 62/528,357, filed on Jul. 3, 2017.

(51) Int. Cl. G06F 3/041; G06F 3/044; G06F 3/047

(52) U.S. Cl. CPC G06F 3/0414; G06F 3/0412; G01L 1/16; G06F 3/047; G06F 3/044

(57) ABSTRACT

Various embodiments concern piezoelectric sensors that can be used as ultrasonic transmitters and/or receivers. Piezoelectric sensors can be embedded within, or connected to, a medium. For example, a piezoelectric sensor could be embedded within a chassis, a protective substrate disposed above a display, or a substrate laid within a break in the chassis. An array of piezoelectric sensors can generate a high-frequency ultrasound vibration field that is continuously and uniformly propagated across the medium. These propagating ultrasound waves enable detection of objects touching the surface of the medium. More specifically, during a touch event, ultrasound waves will be reflected back toward the piezoelectric sensors. A controller can determine the location of the touch event based on which piezoelectric sensor(s) detect reflected ultrasound waves and/or characteristic(s) of those reflected ultrasound waves.

### CROSS-REFERENCE TO RELATED APPLICATIONS

This application claims priority to and the benefit of U.S. Provisional Patent Application No. 62/559,301, titled “TOUCH-SENSITIVE ELECTRONIC DEVICE CHASSES” and filed Sep. 15, 2017, and U.S. Provisional Patent Application No. 62/528,357, titled “TECHNOLOGIES FOR HANDHELD DEVICES” and filed Jul. 3, 2017, each of which is incorporated herein by reference in its entirety.

### RELATED FIELD

Various embodiments generally concern mechanisms for enabling touch functionality on electronic devices. More specifically, various embodiments relate to mechanisms able to detect touch events from high-frequency waveforms reflected by the responsible object(s).

### BACKGROUND

Many types of electronic devices exist today that present graphical user interfaces on a display. Examples of display technologies include liquid crystal display (LCD) technologies, light-emitting diode (LED) technologies, and gas plasma technologies. In some instances a user will interact with a graphical user interface using a mechanically-actuated input device such as a mouse or keyboard button, while in other instances a user will interact with a graphical user interface using an electronically-activated input device such as touchscreen. The user may view content (e.g., text and graphics) on the display, and then interact with the content using the input device. For instance, a user could choose to issue a command, make a selection, or move a cursor within the bounds of the graphical user interface.

Touch-sensitive displays allow users to provide input through simple gestures by touching the display with a stylus or a finger. Rather than use a mechanically-actuated input device, users can instead interact directly with the content being shown on the display. Touch-sensitive displays are becoming an increasingly popular option for many electronic devices due to the improved marketability and ease of use of such displays.

### SUMMARY

Touch-sensitive displays are becoming increasingly common in electronic devices. However, conventional under-display touchscreen technology suffers from several drawbacks. For example, under-display touchscreen technology must be mounted on a substantially flat substrate, and thus may be difficult to readily incorporate into displays having curved surfaces. As another example, under-display touchscreen technology can become prohibitively expensive when the display exceeds a specified size (e.g., generally a diagonal size of approximately 13-15 inches). Consequently, large-scale displays typically employ some other technology to replicate the touch functionality enabled by under-display touchscreen technology.

Introduced here, therefore, are mechanisms for enabling touch functionality on electronic devices. More specifically, piezoelectric sensors able to detect touch events along a surface from high-frequency waveforms reflected by the responsible object(s). A responsible object could be, for example, a stylus, finger, etc. Such technology may be particularly useful for enabling touch functionality on unconventional displays where conventional under-display touchscreen technology would not provide sufficient sensitivity/resolution, would be prohibitively expensive, etc.

Piezoelectric sensors can be used as ultrasonic transmitters and/or receivers. In some embodiments the piezoelectric sensors include a separate transmitter and receiver, while in other embodiments the piezoelectric sensors include a transceiver able to both transmit and receive ultrasound waveforms.

Generally, an electronic device will include multiple piezoelectric sensors that are disposed around the perimeter of the display. For example, an array of piezoelectric sensors may be embedded within the protective substrate with which the user interacts. As another example, an array of piezoelectric sensors may be embedded within the edge of the chassis. The piezoelectric sensors may be sufficiently sensitive that they eliminate the need for touch circuitry to be included beneath the display. Alternatively, an electronic device could include both piezoelectric sensors and touch circuitry located beneath the display.

An array of piezoelectric sensors can generate a high-frequency ultrasound vibration field that is continuously and uniformly propagated across a medium. The medium can include a first surface with which the user can interact and a second surface opposite the first surface. In some embodiments the second surface is connected to the array of piezoelectric sensors, while in other embodiments the piezoelectric sensors are embedded within the medium between the first and second surfaces. The medium could be, for example, the protective substrate arranged above a display layer, the structural chassis, etc.

These propagating ultrasound waves enable detection of objects touching the surface of the medium in a manner similar to that of sonar. During a touch event, ultrasound waves will be reflected back toward the piezoelectric sensors. A controller can determine the location of the touch event based on which piezoelectric sensor(s) detect reflected ultrasound waves. For example, time of flight can be used to determine the location of the touch event, while wave amplitude may be used to determine the force of the touch event. Thus, the controller may be able to simultaneously determine an x-coordinate, y-coordinate, and force corresponding to a touch event.

### BRIEF DESCRIPTION OF THE DRAWINGS

Various features and characteristics of the technology will become more apparent to those skilled in the art from a study of the Detailed Description in conjunction with the drawings. Embodiments of the technology are illustrated by way of example and not limitation in the drawings, in which like references may indicate similar elements.

FIG. 1 depicts an electronic device that includes a display disposed within a chassis (also referred to as a “housing”).

FIG. 2 is an exploded perspective view of a conventional display assembly for an electronic device.

FIG. 3A depicts a piezoelectric material, as may be used in various embodiments.

FIG. 3B is a side view of an example piezoelectric sensor, as may be used in various embodiments.

FIG. 4 is an exploded perspective view of a display assembly that includes an array of piezoelectric sensors arranged around the periphery of a display layer.

FIG. 5 depicts an array of piezoelectric sensors that are embedded within the chassis of an electronic device.

FIG. 6 depicts a mechanism for enabling touch functionality along a medium of an electronic device.

FIG. 7 includes several different views of an electronic device (here, a mobile phone) that includes one or more piezoelectric sensors.

FIG. 8 depicts a process for manufacturing an electronic device that includes one or more piezoelectric sensors, which are capable of detecting touch events along a surface of the electronic device.

FIG. 9 depicts a process for detecting touch events along the surface of a medium.

FIG. 10 is a block diagram illustrating an example of a processing system in which at least some operations described herein can be implemented.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

Mechanisms for enabling touch functionality on electronic devices are described herein. More specifically, piezoelectric sensors can be used as ultrasonic transmitters and/or receivers.

Piezoelectric sensors can be embedded within metal, polymer (e.g., plastic polymers such as polycarbonate), ceramic, plastic, glass, etc. For example, a piezoelectric sensor could be embedded within (or connected to) a metal chassis comprised of aluminum, titanium, copper, magnesium, etc. As another example, a piezoelectric sensor could be embedded within (or connected to) a protective substrate comprised of glass, plastic, etc. As yet another example, a piezoelectric sensor could be embedded within (or connected to) a substrate laid within a break in the chassis. The break may be necessary for permitting antenna(s) within the chassis to send/receive signals or could be for stylistic/aesthetic purposes. The substrate may be comprised of metal, ceramic, plastic, glass, etc.

Note, however, that the piezoelectric sensors described here are generally not embedded within optically-clear materials through which the user is expected to look because the piezoelectric sensors themselves are not optically transparent. Accordingly, piezoelectric sensors are typically offset from the display layer of the electronic device.

An array of piezoelectric sensors can generate a high-frequency ultrasound vibration field that is continuously and uniformly propagated across a medium. These propagating ultrasound waves enable detection of objects touching the surface of the medium in a manner similar to that of sonar. During a touch event, ultrasound waves will be reflected back toward the piezoelectric sensors. A controller can determine the location of the touch event based on which piezoelectric sensor(s) detect reflected ultrasound waves.

### Terminology

References in this description to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”). The terms “connected,” “coupled,” or any variant thereof is intended to include any connection or coupling, either direct or indirect, between two or more elements. The coupling/connection can be physical, logical, or a combination thereof. For example, two devices may be electrically or communicatively coupled to one another despite not sharing a physical connection.

When used in reference to a list of multiple items, the word “or” is intended to cover all of the following interpretations: any of the items in the list, all of the items in the list, and any combination of items in the list.

### Technology Overview

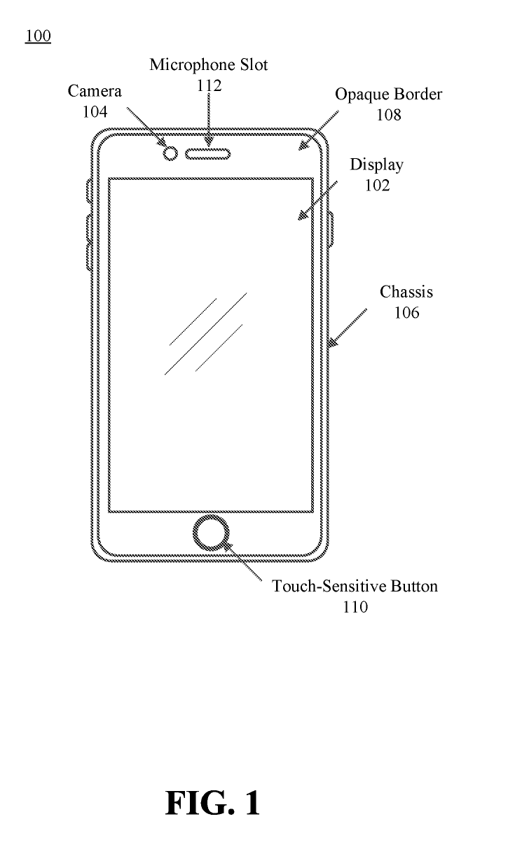

FIG. 1 depicts an electronic device 100 that includes a display 102 disposed within a chassis 106 (also referred to as a “housing”). Other features can be offset from the display 102, though such a design limits the size of the display. Here, for example, a front-facing camera 104, touch-sensitive button 110, and microphone slot 112 are located within an opaque border 108 that surrounds the display 102. The opaque border 108 is not responsive to user interactions in conventional electronic devices. The opaque border 108 is often used to hide components (e.g., sensors, connectors, and a power supply) that reside within the electronic device 100.

Certain embodiments are described in the context of a mobile phone for the purpose of illustration only. Those skilled in the art will recognize that the technology is readily applicable to other electronic devices for which touch functionality is desirable. For example, the technology could also be used in conjunction with desktop computers, tablet computers, personal digital assistants (PDA), game consoles (e.g., Sony PlayStation® or Microsoft Xbox®), music players (e.g., Apple iPod Touch®), wearable electronic devices (e.g., watches or fitness bands), network-connected (“smart”) devices (e.g., a television or home assistant device), virtual/augmented reality systems (e.g., head-mounted displays such as Oculus Rift® and Microsoft Hololens®), point-of-sale (POS) systems, electronic voting machines, or other electronic devices.

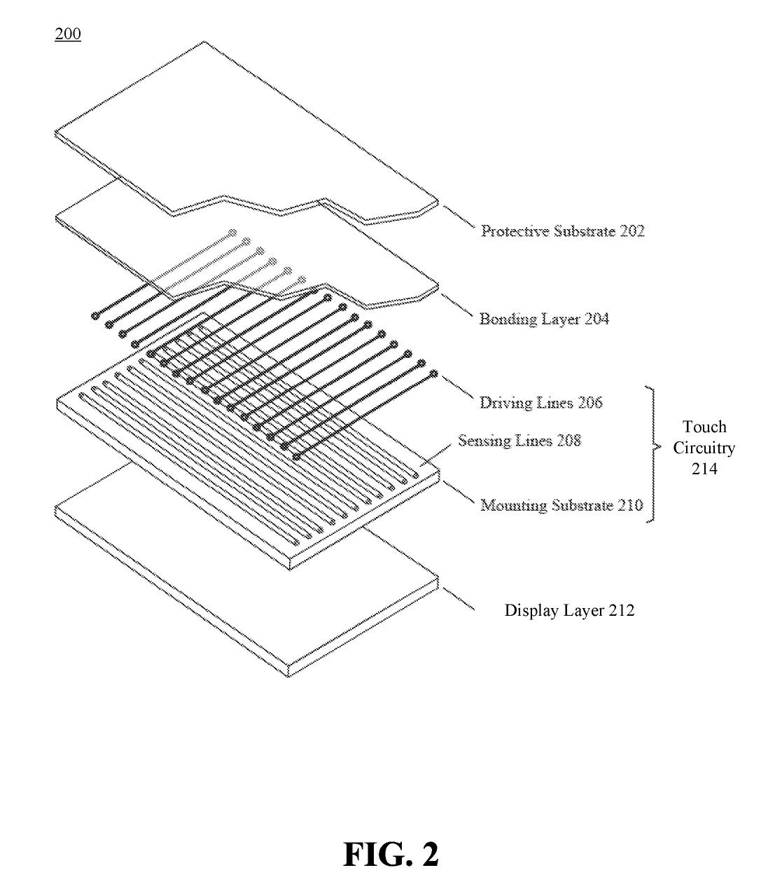

FIG. 2 is an exploded perspective view of a conventional display assembly 200 for an electronic device. The display assembly 200 can include a protective substrate 202, an optically-clear bonding layer 204, driving lines 206 and sensing lines 208 disposed on a mounting substrate 210, and a display layer 212. Various embodiments can include some or all of these layers, as well as other layers not shown here such as optically-clear adhesive layers.

The protective substrate 202 enables a user to interact with the display assembly 200. The protective substrate 202 includes two sides: an outward-facing side with which a user is able to make contact, and an inward-facing side that is directly adjacent to another layer of the display assembly 200 (e.g., the touch circuitry 214 or the display layer 212). The protective substrate 202 is preferably substantially or entirely transparent. The protective substrate 202 can be comprised of glass, plastic, or any other suitable material (e.g., crystallized aluminum oxide).

Together, the driving lines 206 and sensing lines 208 include multiple electrodes (“nodes”) that create a coordinate grid for the display assembly 200. The coordinate grid may be used by a processor on a printed circuit board assembly (PCBA) to determine the intent of a user interaction with the protective substrate 202. The driving lines 206 and/or sensing lines 208 can be mounted to, or embedded within, a mounting substrate 210. The mounting substrate 210 is preferably comprised of a substantially or entirely transparent material, such as glass or plastic. The driving lines 206, sensing lines 208, and/or mounting substrate 210 are collectively referred to herein as “touch circuitry 214.”

An optically-clear bonding layer 204 may be used to bind the protective substrate 202 to the touch circuitry 214, which generates signals responsive to a user interaction with the protective substrate 202. The bonding layer 204 can include an acrylic-based adhesive or a silicon-based adhesive, as well as one or more layers of indium-tin-oxide (ITO). Moreover, the bonding layer 204 is preferably substantially or entirely transparent (e.g., greater than 99% light transmission) and may display good adhesion to a variety of substrates, including glass, polyethylene (PET), polycarbonate (PC), polymethyl methacrylate (PMMA), etc.

A display layer 212 is configured to display content with which the user may be able to interact. The display layer 212 could include, for example, a liquid crystal display (LCD) panel and a backlight assembly (e.g., a diffuser and a backlight) that is able to illuminate the LCD panel. Other display technologies could also be used, such as light-emitting diodes (LEDs), organic light-emitting diodes (OLED), electrophoretic/electronic ink (“e-ink”), etc. Air gaps may be present between or within some of these layers. For example, an air gap may be present between the diffuser and the backlight in the backlight assembly.

Those skilled in the art will also recognize that these layers may be stacked together in different orders. For example, the touch circuitry 214 could be mounted behind the display layer 212, in which case the touch circuitry 214 may react to deformation of the protective substrate 202 and the display layer 212 due to an applied pressure.

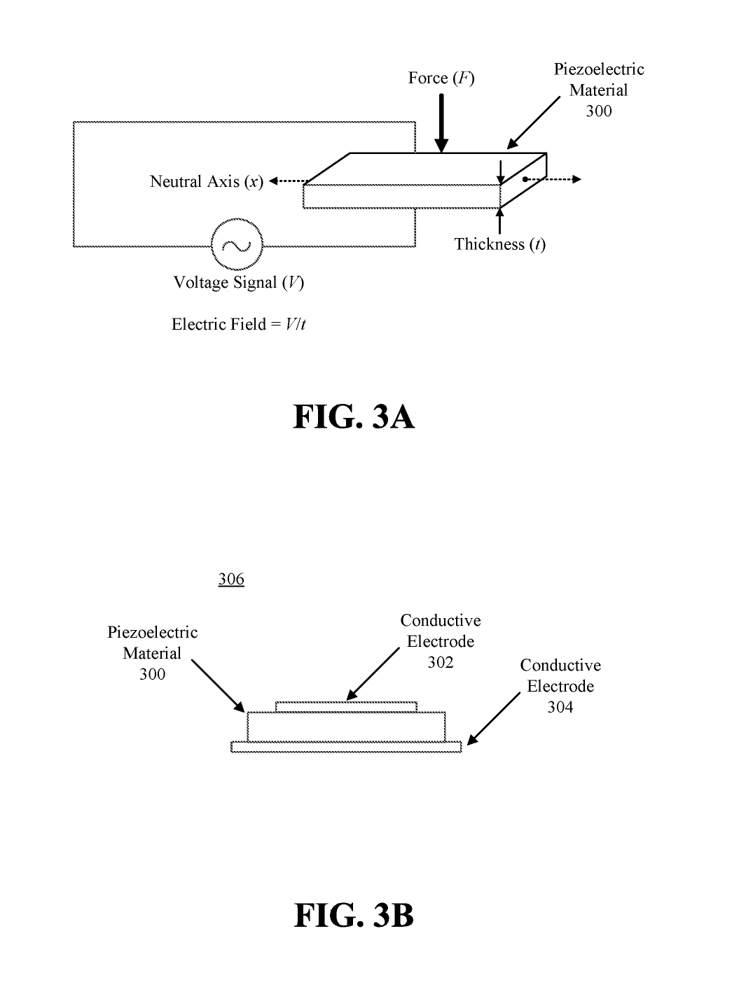

FIG. 3A depicts a piezoelectric material 300, as may be used in various embodiments. A piezoelectric sensor is a device that uses a piezoelectric material 300 to measure changes in pressure, acceleration, temperature, strain, or force by converting them to an electrical charge.

The piezoelectric material 300 can generate an electrical signal when deformed. For example, when a force (F) displaces the piezoelectric material 300 along a neutral axis (x), the piezoelectric material 300 can generate a voltage signal (V) proportional to the applied force, pressure, or strain. The voltage signal (V) may be independent of the size and shape of the piezoelectric material 300. Another benefit of piezoelectric materials is that they can convert electric fields into mechanical excitation, and vice versa. Accordingly, an electronic device could also induce a haptic response by supplying a voltage to the piezoelectric material 300.

Piezoelectric sensors can be designed in several different ways. For example, a piezoelectric sensor may include a piezoelectric material layer comprised of a ceramic (e.g., lead zirconate titante (PZT)). As another example, a piezoelectric sensor may include a piezoelectric material layer comprised of a single crystal material (e.g., gallium phosphate, quartz, or tourmaline). Ceramic materials generally have a piezoelectric constant/sensitivity that is roughly two orders of magnitude higher than those of single crystal materials.

FIG. 3B is a side view of an example piezoelectric sensor 306, as may be used in various embodiments. Here, the piezoelectric material 300 is disposed between conductive electrodes 302, 304. The conductive electrodes 302, 304 may be comprised of metal or some other conductive material. For example, one electrode (e.g., electrode 304) may be a metal sheet, while the other electrode (e.g., electrode 302) may be a conductive coating such as silver plating.

A capacitance can be formed because the piezoelectric material 300 acts as a dielectric between the conductive electrodes 302, 304. As the thickness and/or shape of the piezoelectric material 300 varies due to an applied pressure, the distance between the conductive electrodes 302, 304 also varies, thereby changing the capacitance of the piezoelectric sensor 306.

As further described below, piezoelectric sensors can work either in of two modes: voltage displacement and motion displacement. Thus, a user (or an electronic device) can displace a piezoelectric sensor to generate a voltage, or a user (or an electronic device) can apply a voltage to generate a displacement.

For voltage displacement, an array of piezoelectric sensors works because some piezoelectric sensors are passive while other piezoelectric sensors are active. For example, some piezoelectric sensors may be actively vibrating at 500 kilohertz (kHz) and other piezoelectric sensors may be configured to detect when a touch object (e.g., a finger) causes attenuation of the signal. These other piezoelectric sensors can detect the amount displaced (e.g., they receive 480 kHz rather than 500 kHz).

Multiple piezoelectric sensors are typically disposed around the perimeter of an electronic device. Because the piezoelectric sensors are typically very small, the piezoelectric sensors could be placed on nearly any area of the electronic device.

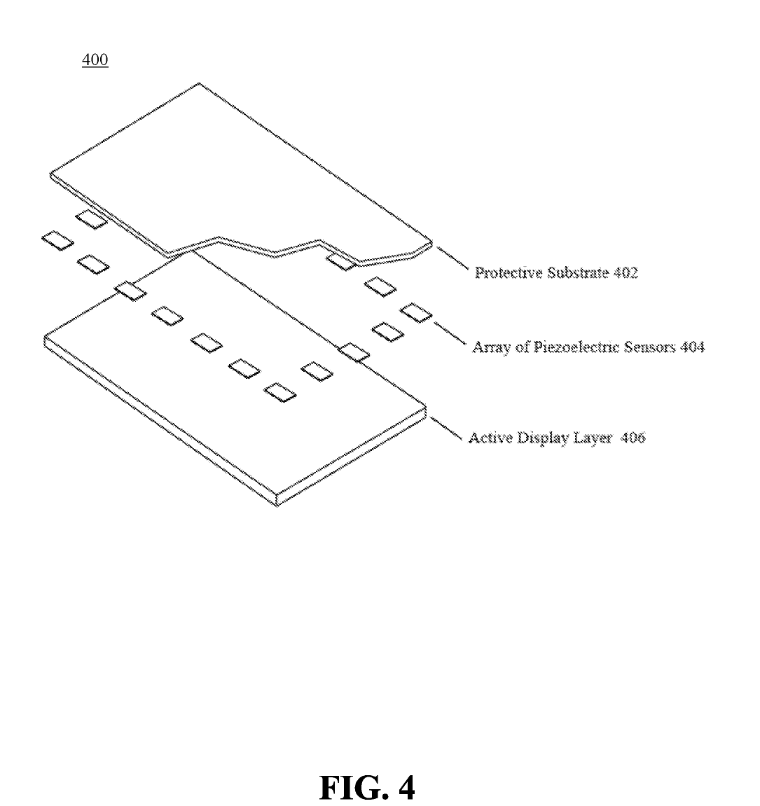

For example, FIG. 4 is an exploded perspective view of a display assembly 400 that includes an array of piezoelectric sensors 404 arranged around the periphery of a display layer 406. Here, the piezoelectric sensors 404 are uniformly arranged along the perimeter of the display assembly 400. However, the piezoelectric sensors 404 could be arranged in several different patterns (e.g., near each corner of the display assembly 400, along the longitudinal/latitudinal sides of the display assembly 400, etc.).

The piezoelectric sensors 404 themselves are generally not optically transparent. Accordingly, the piezoelectric sensors 404 are typically not arranged over the display layer 406. Instead, the piezoelectric sensors 404 are often offset from the display layer 406 by a specified distance. For example, the piezoelectric sensors 404 may be disposed beneath the opaque border that typically surrounds the display layer 408 (e.g., opaque border 108 of FIG. 1).

However, because the piezoelectric sensors 404 do not need to be in place with touch events, the technology can allow electronic devices to become thinner. As further described below, the piezoelectric sensors can be placed along the edge where conventional electronic devices generally do not position many components. The piezoelectric sensors may be placed in an undercut accessible along the periphery of the electronic device.

In some embodiments, the piezoelectric sensors are embedded within a metal band that extends around the electronic device. These piezoelectric sensors can work with the protective substrate because there is typically a stiff glue bond between the protective substrate and the metal band. Such techniques are also applicable to an electronic device having an all-glass enclosure.

The piezoelectric sensors 404 may be sufficiently sensitive that they eliminate the need for touch circuitry to be included in the display assembly 400. Thus, fewer layers may exist between the protective substrate 402 and the display layer 406. Some layers (e.g., optically-clear adhesive layers) that are not pertinent to the technology are not shown here.

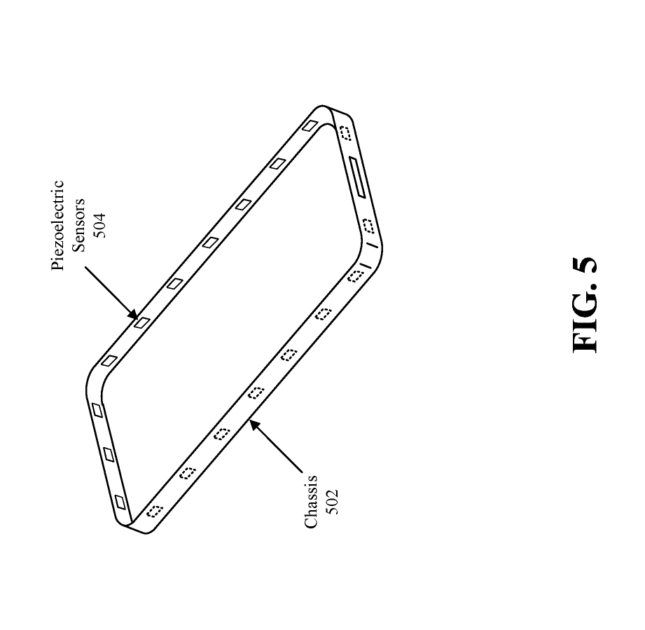

As another example, FIG. 5 depicts an array of piezoelectric sensors 504 that are embedded within the chassis 502 of an electronic device. The chassis 502 (also referred to as a “chassis shell” or “housing”) can include a base panel and multiple sidewalls arranged substantially orthogonal to the base panel. The base panel has two sides: an outward-facing side with which a user is able to make contact, and an inward-facing side that is adjacent to the internal circuitry of the electronic device. Piezoelectric sensors 504 can be embedded within the base panel and/or the sidewalls.

Piezoelectric sensors can be embedded within metal, polymer (e.g., plastic polymers such as polycarbonate), ceramic, plastic, glass, etc. For example, a piezoelectric sensor could be embedded within (or connected to) a metal chassis comprised of aluminum, titanium, copper, magnesium, etc. As another example, a piezoelectric sensor could be embedded within (or connected to) a protective substrate comprised of glass, plastic, etc. As yet another example, a piezoelectric sensor could be embedded within (or connected to) a substrate laid within a break in the chassis. The break may be necessary for permitting antenna(s) within the chassis to send/receive signals or could be for stylistic/aesthetic purposes. The substrate may be comprised of metal, ceramic, plastic, glass, etc.

Note, however, that the piezoelectric sensors described here are generally not embedded within optically-clear materials through which the user is expected to look because the piezoelectric sensors themselves are not optically transparent. Accordingly, piezoelectric sensors are typically offset from the display layer of the electronic device.

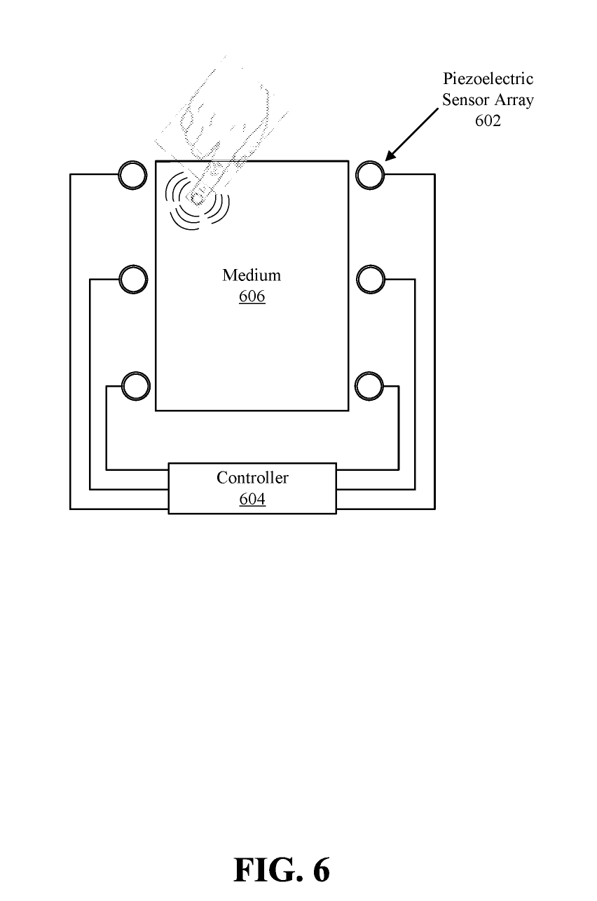

FIG. 6 depicts a mechanism 600 for enabling touch functionality along a medium 606 of an electronic device. More specifically, piezoelectric sensors 602 can be configured to detect touch events performed on the surface of the medium 606 from high-frequency waveforms reflected by the responsible object(s). A responsible object could be, for example, a stylus, finger, etc.

Each piezoelectric sensor 602 can be used as an ultrasonic transmitter and/or receiver. In some embodiments, each piezoelectric sensor includes a separate transmitter and receiver. In other embodiments, each piezoelectric sensor includes a transceiver able to both transmit and receive ultrasound waveforms. In other embodiments, some piezoelectric sensors may be used as transmitters while other piezoelectric sensors may be used as receivers.

As shown here, an electronic device will typically include multiple piezoelectric sensors 602 that are disposed near the medium 606. In some embodiments the piezoelectric sensors 602 are embedded within the medium, while in other embodiments the piezoelectric sensors 602 are positioned directly adjacent to the medium 606 so that ultrasonic waves emitted by the piezoelectric sensors 602 can travel through the medium 606 in an unimpeded manner.

Together, the piezoelectric sensors 602 can generate a high-frequency vibration field that is continuously and uniformly propagated across the medium 606. Generally, the carrier frequency of the high-frequency vibration field is set above the audible frequency range for humans (which is approximately 20 kHz). For example, the carrier frequency may be 100 kHz, 250 kHz, 500 kHz, etc. These propagating ultrasound waves enable detection of objects touching the surface of the medium 606 in a manner similar to that of sonar. During a touch event, ultrasound waves will be reflected back toward the piezoelectric sensors 602.

Each of the piezoelectric sensors 602 can be coupled to a controller 604, which can employ signal processing on waveforms generated by the piezoelectric sensor(s). Examples of controllers include processors and application-specific integrated circuits (ASICs).

The controller 604 can determine the location of a touch event based on which piezoelectric sensor(s) detect reflected ultrasound waves. For example, time of flight can be used to determine the location of the touch event, while wave amplitude may be used to determine the force of the touch event. Thus, the controller 604 may be able to simultaneously determine an x-coordinate, y-coordinate, and force corresponding to a touch event. The same information could be used to assign locations to each touch object involved in a multi-touch event. However, in such a scenario, the controller 604 may also determine which ultrasound wave goes with which touch object.

Each piezoelectric sensor may be tuned to the shape, composition, etc., of the medium through which the high-frequency waves travel. As such, the controller 604 can readily determine exactly where a touch event occurred (e.g., by detecting a break in a node of vibration detected by a given piezoelectric sensor that can be triangulated based on the other piezoelectric sensors).

Several advantages exist when the piezoelectric sensors 602 are employed as shown in FIG. 6. For example, because the piezoelectric sensors 602 operate as ultrasound transmitters/receivers, touch functionality does not require deflection of the medium 606. Instead, the ultrasound waves allow force, pressure, or strain to be measured via a coupling between the touch object that contacts the medium 606 and the ultrasound wave. The zero-deflection requirement also allows forces, pressures, or strains to be detected on highly rigid and/or curved surfaces.

While certain embodiments are described in the context of piezoelectric sensors, those skilled in the art will recognize that other transmitters/receivers could be used. Examples of transmitters include piezoelectric transducers, electromagnetic transducers, transmitters, and other sensors capable of propagating ultrasonic waves through the medium 606. Similarly, examples of receivers include piezoelectric transducers, electromagnetic transducers, transmitters, and other sensors capable of detecting ultrasonic waves traveling through the medium 606.

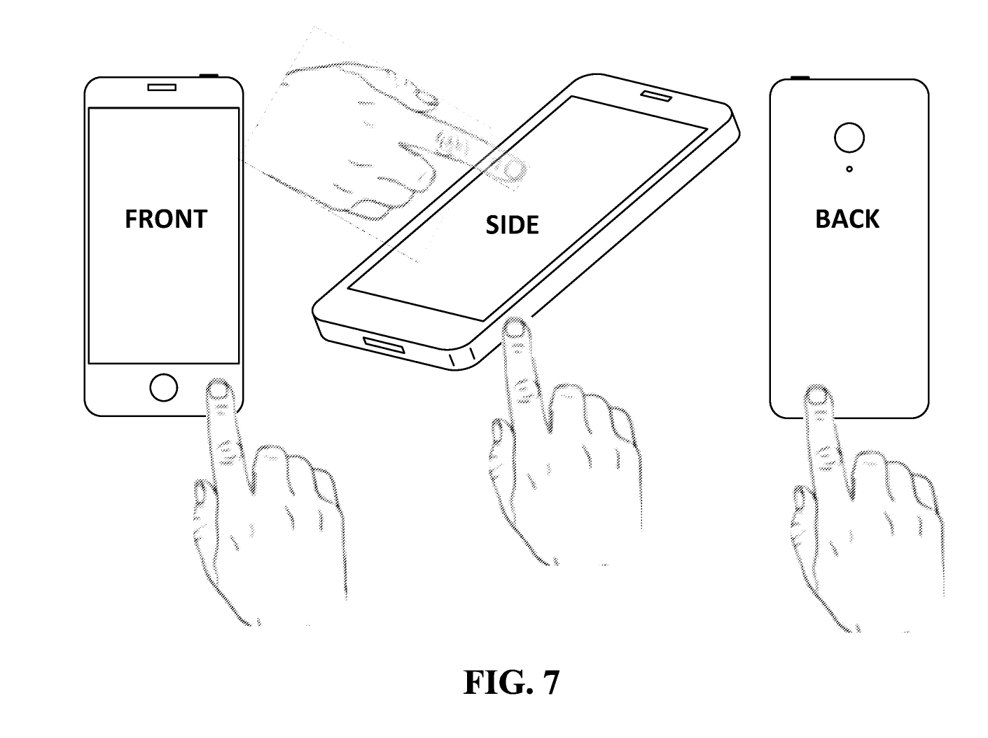

FIG. 7 includes several different views of an electronic device (here, a mobile phone) that includes one or more piezoelectric sensors. As noted above, the piezoelectric sensor(s) can be disposed along the front surface, side surface(s), and/or back surface of the electronic device. Some or all of these surfaces may be touch enabled.

For example, the entire housing of the electronic device may be touch enabled. In some embodiments, this is accomplished by placing piezoelectric sensor(s) within/near the protective substrate accessible along the front side of the electronic device and/or within/near the base panel of the chassis accessible along the back side of the electronic device. In other embodiments, this is accomplished by placing piezoelectric sensor(s) within/near the sidewalls of the chassis.

In such embodiments, certain zones may correspond to specified controls. For example, a user may be able to wake the electronic device by tapping on the front side of the electronic device. As another example, the user may be able to answer or end a call by swiping a right or left along the back side of the electronic device. As yet another example, the user may be able to modify volume by swiping up or down along the sidewall of the chassis. Zones may correspond to volume controls, camera controls, call controls, and other functions. Moreover, these zones may be located anywhere along the exterior surface of the electronic device.

In some embodiments, the display panel along the front side of the electronic device can have standard complex-touch gesture recognition capabilities, while other areas (e.g., the back side of the electronic device) could use piezoelectric sensors to detect simple gestures, such as swiping up/down/left/right. In some embodiments, an electronic device may include a capacitive touch-sensitive surface along the front and back sides and a piezoelectric touch-sensitive surface along the sidewalls (e.g., along a metal band extending around the electronic device).

An electronic device could also include a mechanical feature, such as a small divot, where certain buttons (e.g., the power button) would conventionally be located. The mechanical feature can indicate the area where a user should touch, thereby creating a virtual button. In such embodiments, a hole in the chassis for placement of a mechanical button is unnecessary. Thus, the technology can be used to avoid the need for hardware input mechanisms (e.g., buttons) because the electronic device may be capable of receiving gesture input that provide the same instructions. For example, the chassis may include a raised area similar to the volume buttons that can detect a simple gesture (e.g., a tap or swipe) indicative of the user's desire to change the volume.

Accordingly, some embodiments concern electronic devices having no buttons whatsoever, which further eases the path to full waterproofing. Said another way, an electronic device can be waterproofed by implementing the technology because it does not require that holes be drilled into the chassis for hardware input mechanisms. Because the electronic device can detect various gestures that correspond to various physical input mechanisms, physical input mechanisms may not be necessary. In such embodiments, the electronic device can be charged via a high-frequency point-to-point communication channel (e.g., SiBEAM or KEYSSA), thus avoiding the need for physical ports (e.g., a USB-C port). Instead, the electronic device can include one or more power pins (also referred to as “electrical contacts”) accessible via sealed hole(s) in the chassis. For example, power pin(s) may be accessible through the base panel of the chassis. Power can be transferred to the electronic device upon initiating and maintaining a physical connection with a corresponding power pin of another electronic device or a power source.

Virtual buttons can be associated with a unique physical shape or a design that is less sharp along the edge than existing hardware buttons. In some embodiments, a visual marker included on the surface of the electronic device may be used to indicate a special region for receiving touch input. Similarly, a display screen may present visual marker(s) that point to the region(s) capable of receiving touch input. For example, a touch-sensitive display may include a series of labels arranged along one side that indicate where a user could touch to provide different input(s).

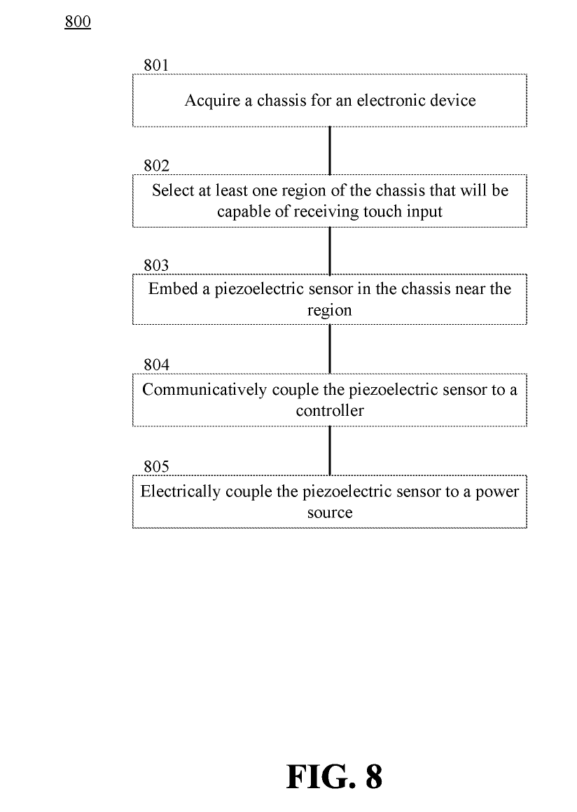

FIG. 8 depicts a process 800 for manufacturing an electronic device that includes one or more piezoelectric sensors, which are capable of detecting touch events along a surface of the electronic device. A chassis for the electronic device is initially received by a manufacturer (step 801). The chassis could be comprised of a metal, polymer (e.g., plastic polymers such as polycarbonate), ceramic, plastic, glass, etc. For example, in some embodiments the chassis is comprised of aluminum, titanium, copper, magnesium, etc.

The manufacturer can then select at least one region of the chassis that will be capable of receiving touch input (step 802). The region can be a subset of the chassis or the entirety of the chassis. The region may be selected because it represents an area that is subject to frequent user interactions (e.g., a sidewall near where volume control would conventionally be located).

A piezoelectric sensor could be embedded within the chassis near the region (step 803). Alternatively, the piezoelectric sensor may be connected to the inner surface of the chassis. The piezoelectric sensor can be used as an ultrasonic transmitter and/or receiver. In some embodiments, the piezoelectric sensor includes a separate transmitter and receiver. In other embodiments, the piezoelectric sensor includes a transceiver able to both transmit and receive ultrasound waveforms. Other embodiments may include multiple piezoelectric sensors, some of which are used as transmitters while others are used as receivers.

The piezoelectric sensor is then communicatively coupled to a controller (step 804). During use of the electronic device, the piezoelectric sensor can generate a high-frequency ultrasound vibration field that is continuously and uniformly propagated across the chassis. The controller can determine the location of touch events within the region based on whether the piezoelectric sensor detects reflected ultrasound waves. For example, time of flight can be used to determine the location of a touch event, while wave amplitude may be used to determine the force of a touch event.

The piezoelectric sensor may also be electrically coupled to a power source (step 805). In such embodiments, haptic responses can be induced by applying a power signal (e.g., a voltage signal) to the piezoelectric sensor. The power source could be, for example, a rechargeable lithium-ion (Li-Ion) battery, a rechargeable nickel-metal hydride (NiMH) battery, a rechargeable nickel-cadmium (NiCad) battery, or any other power source suitable for an electronic user device. Other types of power sources may also be used. For example, some electronic devices may be designed with the intention that they remain electrically coupled to a power source (e.g., an outlet) during use, and therefore do not require batteries at all.

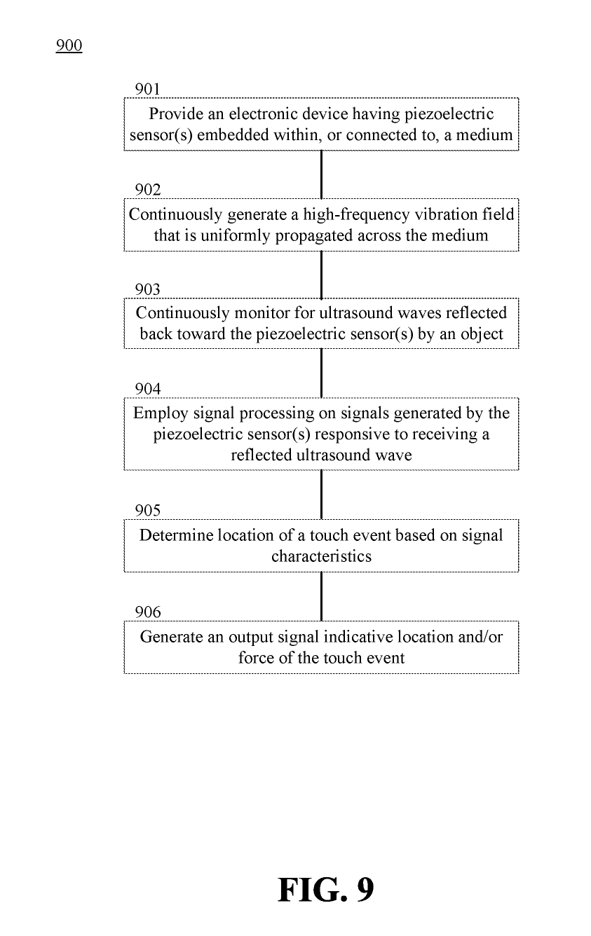

FIG. 9 depicts a process 900 for detecting touch events along the surface of a medium. A medium could be the chassis of an electronic device, the protective substrate covering the display assembly of the electronic device, etc.

The electronic device is initially provided to a user that includes one or more piezoelectric sensors embedded within, or connected to, the medium (step 901). The user is able to interact directly with the outer surface of the medium. Generally, the inner surface of the medium will be adjacent to the internal circuitry of the electronic device.

The piezoelectric sensor(s) can then continuously generate a high-frequency vibration field that is uniformly propagated across the medium (step 902). The carrier frequency of the high-frequency vibration field is set above the audible frequency range for humans (which is approximately 20 kHz). For example, the carrier frequency may be 100 kHz, 250 kHz, 500 kHz, etc.

These propagating ultrasound waves enable detection of objects touching the surface of the medium in a manner similar to that of sonar. More specifically, the piezoelectric sensor(s) can continually monitor for ultrasound waves vibrated back toward the piezoelectric sensor(s) by an object (step 903). The object may be a stylus, finger, etc. As noted above, each piezoelectric sensor can be used as an ultrasonic transmitter and/or receiver. Thus, in some embodiments each piezoelectric sensor is configured to both transmit and receive ultrasound waveforms, while in other embodiments a first set of piezoelectric sensors transmit ultrasound waveforms and a second set of piezoelectric sensors receive ultrasound waveforms.

A controller coupled to the piezoelectric sensor(s) can employ signal processing on signals generated by the piezoelectric sensor(s) responsive to receiving a reflected ultrasound waveform (step 904). More specifically, the controller can determine the location of a touch event based on which piezoelectric sensor(s) detected reflected ultrasound waves and/or characteristic(s) of those reflected ultrasound waves (step 905). For example, time of flight can be used to determine the location of the touch event, while wave amplitude may be used to determine the force of the touch event. Thus, the controller may be able to simultaneously determine an x-coordinate, y-coordinate, and force corresponding to a touch event.

The controller can also generate an output signal indicative of the location and/or force of the touch event (step 906). The output signal may be used for a variety of things. For example, the output signal could be provided to software programs executing on the electronic device that expect user input (e.g., a selection of an element shown on a display). As another example, the output signal could be provided to the operating system executing on the electronic device to specify a change in volume, brightness, etc.

Unless contrary to physical possibility, it is envisioned that the steps described above may be performed in various sequences and combinations. For example, certain piezoelectric sensor(s) may be configured to only generate a high-frequency vibration field for segment(s) of the electronic device (e.g., the display) upon determining the user has awoken the electronic device. Similarly, certain piezoelectric sensor(s) may be configured to continually generate a high-frequency vibration field regardless of sleep status. For example, some segment(s) (e.g., the sidewalls or base panel of the chassis) may be capable of receiving simple user gestures at any time. Other steps may also be included in some embodiments.

### Processing System

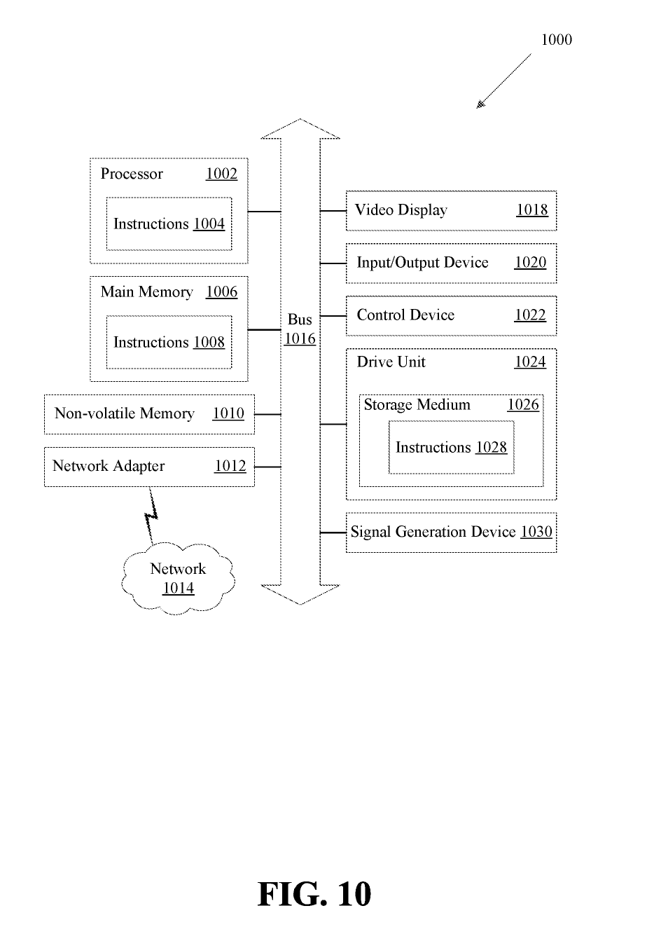

FIG. 10 is a block diagram illustrating an example of a processing system 1000 in which at least some operations described herein can be implemented. For example, some components of the processing system 1000 may be hosted on an electronic device that includes one or more piezoelectric sensors, while other components of the processing system 1000 may be hosted on a device that is communicatively coupled to the electronic device. The device may be connected to the electronic device via a wired channel or a wireless channel.

The processing system 1000 may include one or more central processing units (“processors”) 1002, main memory 1006, non-volatile memory 1010, network adapter 1012 (e.g., network interface), video display 1018, input/output devices 1020, control device 1022 (e.g., keyboard and pointing devices), drive unit 1024 including a storage medium 1026, and signal generation device 1030 that are communicatively connected to a bus 1016. The bus 1016 is illustrated as an abstraction that represents one or more physical buses and/or point-to-point connections that are connected by appropriate bridges, adapters, or controllers. The bus 1016, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The processing system 1000 may share a similar computer processor architecture as that of a desktop computer, tablet computer, personal digital assistant (PDA), mobile phone, game console (e.g., Sony Play Station® or Microsoft Xbox®), music player (e.g., Apple iPod Touch®), wearable electronic device (e.g., a watch or fitness band), network-connected (“smart”) device (e.g., a television or home assistant device), virtual/augmented reality systems (e.g., a head-mounted display such as Oculus Rift® or Microsoft Hololens®), or another electronic device capable of executing a set of instructions (sequential or otherwise) that specify action(s) to be taken by the processing system 1000.

While the main memory 1006, non-volatile memory 1010, and storage medium 1026 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1028. The term “machine-readable medium” and “storage medium” shall also be taken to include any medium that is capable of storing, encoding, or carrying a set of instructions for execution by the processing system 1000.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in a computing device. When read and executed by the one or more processors 1002, the instruction(s) cause the processing system 1000 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1010, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 1012 enables the processing system 1000 to mediate data in a network 1014 with an entity that is external to the processing system 1000 through any communication protocol supported by the processing system 1000 and the external entity. The network adapter 1012 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1012 may include a firewall that governs and/or manages permission to access/proxy data in a computer network, and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following examples should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

1. An electronic device comprising:
a shell member comprising
an outward-facing contact surface, and
an inward-facing surface that is adjacent to internal circuitry of the electronic device;
a plurality of piezoelectric transmitters embedded within the shell member, each piezoelectric transmitter being configured to transmit ultrasound waves that propagate across the outward-facing contact surface of the shell member; and
a plurality of piezoelectric receivers embedded within the shell member, each piezoelectric receiver being configured to generate a signal in response to receiving an ultrasound waveform transmitted by one or more of the plurality of piezoelectric transmitters, as reflected by contact of an object along the outward-facing contact surface of the shell member.

2. The electronic device of claim 1, wherein the shell member is a chassis shell, an optically-clear substrate located above a display assembly, or an optically-opaque substrate affixed within a break in the chassis shell.

3. The electronic device of claim 1, further comprising:
a controller, coupled to the plurality of piezoelectric receivers, configured to:
determine a location of the contact based on time-of-flight measures associated with reflected ultrasound waveforms.

4. The electronic device of claim 3, wherein the controller is further configured to:
determine a force of the contact based on amplitude measures associated with reflected ultrasound waveforms.

5. The electronic device of claim 1, wherein the shell member is a chassis shell, and wherein the electronic device further comprises:
an optically-clear substrate affixed within the chassis shell; and
a display layer located below the optically-clear substrate.

6. The electronic device of claim 5, wherein the optically-clear substrate and the display layer have a curved form.

7. The electronic device of claim 5, wherein electronic device further comprises:
touch circuitry that generates a signal in response to a user interaction with the optically-clear substrate.

8. The electronic device of claim 1, further comprising:
a power source; and
a controller operable to induce a haptic event by causing the power source to selectively apply a voltage to one of the plurality of piezoelectric transmitters or one of the plurality of piezoelectric receivers.

9. A mobile phone comprising:
a chassis shell; and
a plurality of piezoelectric sensors embedded within the chassis shell, wherein the plurality of piezoelectric sensors enable touch functionality along a surface of the chassis shell by
generating an ultrasound vibration field that uniformly propagates across the surface of the chassis shell, and
detecting a ultrasound wave generated by a piezoelectric sensor, as reflected by an object that disrupts the high-frequency vibration field.

10. The mobile phone of claim 9, wherein the chassis shell is comprised of aluminum, titanium, copper, magnesium, or a combination thereof.

11. The mobile phone of claim 9, wherein the chassis shell includes:
a base panel;
opposingly paired lateral sidewalls extending upwardly from the base panel along a width thereof; and
opposingly paired longitudinal sidewalls extending upwardly from the base panel along a length thereof.

12. The mobile phone of claim 11, wherein at least one sidewall includes an opening through which a mechanical input mechanism extends.

13. The mobile phone of claim 11, wherein no sidewalls include an opening through which a mechanical input mechanism extends.

14. The mobile phone of claim 9, wherein the plurality of piezoelectric sensors include:
at least one piezoelectric transmitter configured to generate the ultrasound vibration field; and
at least one piezoelectric receiver configured to generate a signal responsive to receiving the reflected ultrasound waveform.

15. The mobile phone of claim 14, further comprising:
a controller configured to:
determine a location of a touch event based on a time-of-flight measure associated with the reflected ultrasound waveform, and
determine a force of the touch event based on an amplitude measure associated with the reflected ultrasound waveform.

16. A method comprising:
generating, by a piezoelectric transmitter, an ultrasound vibration field that is uniformly propagated across a surface of a shell member included in an electronic device;
enabling a user to interact with the surface of the shell member;
monitoring, by a piezoelectric receiver, for ultrasound waves as reflected by an object that disrupts the ultrasound vibration field during a touch event;
in response to determining that an ultrasound wave has been received by the piezoelectric receiver,
determining, by a controller, a location at which the touch event occurred based on a characteristic of the ultrasound wave; and
generating, by the controller, an output signal that specifies the location of the touch event.

17. The method of claim 16, wherein a carrier frequency of the ultrasound vibration field is 100 kilohertz (kHz), 250 kHz, or 500 kHz.

18. The method of claim 16, wherein the characteristic of the ultrasound wave is a time-of-flight measure.

19. The method of claim 16, further comprising:
determining, by the controller, a force of the touch event based on a magnitude of the ultrasound wave,
wherein the output signal specifies the location and the force of the touch event.

20. The method of claim 16, further comprising:
inducing, by the controller, a haptic event by causing a power source to selectively apply a voltage to the piezoelectric transmitter or the piezoelectric receiver.
